(19) United States
(12) Patent Application Publication
(10) Pub. No.: US 2026/0357102 A1
(43) Pub. Date: Nov. 12, 2026

(54) ACTINIC RADIATION CURABLE COATING COMPOSITION COMPRISING BIOBASED MONOMER

(71) Applicant: ALLNEX BELGIUM, S.A., Drogenbos (BE)

(72) Inventors: Luc LINDEKENS, MERCHTEM (BE); Patrice ROOSE, Sint Pieters Leeuw (BE); Guido VANMEULDER, Lot (BE)

(73) Assignee: ALLNEX BELGIUM, S.A., Drogenbos (BE)

(21) Appl. No.: 19/131,631

(22) PCT Filed: Oct. 10, 2023
(86) PCT No.: PCT/EP2023/078019

§ 371 Date: May 21, 2025

(30) Foreign Application Priority Data
Dec. 22, 2022 (EP) 22215977.4

(51) Int. Cl. C09D 135/02; C08F 222/10; C09D 4/00; C09D 15/00

(52) U.S. Cl. CPC C09D 135/02; C08F 222/1063; C09D 4/00; C09D 15/00

(57) ABSTRACT

Present invention relates to an actinic radiation curable coating composition comprising from 10 wt % to 90 wt %, based on the total weight of the coating composition, of a poly(trimethylene ether) (meth)acrylate compound A having at most two (meth)acrylate groups obtainable by a condensation reaction of biobased 1,3 poly(trimethylene ether) glycol and a (meth)acrylate compound selected from the group consisting of (meth)acrylic acid, (meth)acryloyl chloride, and/or alkylesters thereof; wherein the biobased 1,3 poly(trimethylene ether) glycol has a number average molecular weight Mn of from 350 to 600 g/mol, more preferably from 400 to 550 g/mol; and from 10 wt % and 89.99 wt %, based on the total weight of the coating composition, of an ethylenically unsaturated oligomer compound B different from compound A, wherein compound B has a viscosity at 25 °C of more than 5 Pa s.

### TECHNICAL FIELD

The present invention relates to an actinic radiation curable coating composition comprising a poly(trimethylene ether) (meth)acrylate and an ethylenically unsaturated oligomer compound having a high viscosity, which coating composition exhibits high performing coating properties after curing. The present invention further relates to a method for forming a coating on a substrate with such coating composition; and to the use of the poly(trimethylene ether) (meth)acrylate as a diluting monomer in such actinic radiation curable coating composition.

### BACKGROUND

Actinic radiation curable compositions are used for many years for many types of coating applications and typically involve (meth)acrylate compounds. Many of the coating compositions comprise viscous (meth)acrylate oligomers that can provide specific properties to the applied material after curing. Typical types of properties involve flexibility, toughness, solvent/stain resistance and glass transition properties, which are controlled by the viscous (meth)acrylate oligomers present in the formulation. While for some applications high viscosity resins can be used, in other applications, it can be more practical to use low viscosity resins. It is well known in the art that diluting monomers, which are low-viscous (meth)acrylate compounds, are often added to these oligomers to adjust the viscosity. It is important to control the balance so that the properties that are provided by the oligomer can be maintained as much as possible and are not diminished by adding too much diluting monomer. Indeed, a too high content of monomer may e.g. lead to a coating with an increased brittleness after curing. Also the type of monomer that is selected has an effect on the properties of the final coating.

In general, there is a growing demand in the market for more sustainable coatings and thus also more sustainable actinic radiation curable compositions. One way to increase sustainability of the resins is by increasing the biobased carbon content. Patent Application with publication number WO2012 024402 describes biobased radiation curable coating compositions having poly(trimethylene ether)urethane (meth)acrylates that are made by reacting isocyanates with biobased poly(trimethylene ether) diol. It is described that these compounds have a very high viscosity and a lot of monomers are used to decrease the viscosity.

It is an object of the invention to provide an actinic radiation curable composition, which has an increased sustainability. It is further an object to provide a diluting monomer suitable for actinic radiation curable compositions which has a biobased carbon content while maintaining or improving the coating properties of the formulation wherein the monomer is used. It is further an object to provide a molecule that helps to increase the biobased carbon content of a coating composition.

### SUMMARY

In a first aspect, present invention relates to an actinic radiation curable coating composition comprising the following compounds:
a. from 10 wt % to 90 wt %, based on the total weight of the coating composition, of a poly(trimethylene ether) (meth)acrylate compound A having at most two (meth)acrylate groups obtainable by a condensation reaction of biobased 1,3 poly(trimethylene ether) glycol and a (meth)acrylate compound selected from the group consisting of (meth)acrylic acid, (meth)acryloyl chloride, and/or alkylesters thereof; wherein the biobased 1,3 poly(trimethylene ether) glycol has a number average molecular weight Mn of from 350 to 600 g/mol, more preferably from 400 to 550 g/mol;
b. from 10 wt % and 89.99 wt %, based on the total weight of the coating composition, of an ethylenically unsaturated oligomer compound B different from compound A, wherein compound B has a viscosity at 25 °C of more than 5 Pa s;
c. optionally, a low molecular weight ethylenically unsaturated monomer compound C;
d. optionally, a further compound D which is a polymer without a reactive ethylenically unsaturated group.

According to another aspect, present invention relates to the use of the poly(trimethylene ether) (meth)acrylate compound A having at most two (meth)acrylate groups as a diluting monomer in an actinic radiation curable coating composition.

In still another aspect of present invention, is provided a method of forming a coating comprising applying a layer of the actinic radiation curable coating composition according to the first aspect, to at least a portion of a substrate and submitting the coated substrate to curing conditions.

In yet another aspect, present invention is related to the use of the actinic radiation curable composition according to the first aspect in additive manufacturing, laminating adhesives, water proofing membranes or inks.

In another aspect, present invention is related to a substrate that is in contact with a coating composition according to the first aspect.

### FIGURES

FIG. 1: Mw distribution of PPDODA as determined by standard gel permeation chromatography (GPC). FIG. 1 shows the Mw distribution plot of poly(trimethylene ether) di-acrylate of example 1 wherein the X-as shows the Log Mw in g/mol and the Y-ax shows dW/d Log Mw (normalized distribution of slice molecular weights or weight normalized area of the slice).

### DETAILED DESCRIPTION

The first aspect is related to the actinic radiation curable coating composition comprising the following compounds:
from 10 wt % to 90 wt %, based on the total weight of the coating composition, of a poly(trimethylene ether) (meth)acrylate compound A having at most two (meth)acrylate groups obtainable by a condensation reaction of biobased 1,3 poly(trimethylene ether) glycol and a (meth)acrylate compound selected from the group consisting of (meth)acrylic acid, (meth)acryloyl chloride, and/or alkylesters thereof; wherein the biobased 1,3 poly(trimethylene ether) glycol has a number average molecular weight Mn of from 350 to 600 g/mol, more preferably from 400 to 550 g/mol;
from 10 wt % and 89.99 wt %, based on the total weight of the coating composition, of an ethylenically unsaturated oligomer compound B different from compound A, wherein compound B has a viscosity at 25 °C of more than 5 Pa s;
optionally, a low molecular weight ethylenically unsaturated monomer compound C;
optionally, a further compound D which is a polymer without a reactive ethylenically unsaturated group.

It is surprisingly found that the actinic radiation curable coating composition according to the first aspect provides after curing a coating with high toughness and elongation/elasticity. The composition is suitable for coating substrates such as wood, where it has an excellent stain, scratch abrasion and impact resistance and provides no yellowing after curing. Further, the radiation curable coating composition according to the first aspect has a high reactivity when cured and provides a coating with an excellent adhesion. In addition the pigment wetting when applying pigmented topcoats is also improved, when compared with coating formulations that are made with conventional monomers.

It was also surprisingly found that the poly(trimethylene ether) (meth)acrylate compound A having at most 2 (meth)acrylate groups can be used as a diluting monomer, providing the same or even better performances compared to di-(meth)acrylate monomers that are known in the market such as TPGDA or DPGDA. Further, it is found that this compound is a good replacement compared to other well-known based biobased monomers such as propoxylated glycerol triacrylate (also called OTA). In addition, the poly(trimethylene ether) (meth)acrylate compound A is able the soften the harder oligomers so that the coating is less brittle when compared with other types of known monomers, when used at the same concentration.

As used herein, “biobased compounds” or “biogenic compounds” or “compounds with carbon-content from natural or renewable resources” or “compounds having a biogenic carbon content” or “compounds having biocarbon content” can be used interchangeably and all refer to compounds sourced from or made from natural renewable resources, such as, for example, bio-mass or plantbased sources.

Currently, there exists at least two different techniques for measuring the 14C content of a sample (i) by liquid scintillation counting or (ii) by mass spectrometry in which the sample is transformed in CO2 and then reduced to graphite for analysis in the mass spectrometer to separate the 14C atoms from the 12C atoms and determine their ratio. All these methods for measuring the 14C content of substances are clearly described in the American standards ASTM D 6866 or ASTM D 7026 as well as in the European standards EN 16785 or EN 16640.

The values of the biobased carbon content according to his invention are measured using the accelerated mass spectrometry protocol described in the standard ASTM D 6866-22.

According to this invention, when is mentioned that a compound/composition has e.g. at least 20% biocarbon content, this means that at least 20% carbon is from biobased origin in view of the total carbon content of that compound/composition.

In one embodiment, the biocarbon content of compound A, compound B and compound C and/or compound D, if present, is more than 5%, preferably above 10%, more preferably above 30%, even more preferably above 50%, by weight of the total carbon content, wherein the biocarbon content is measured using the accelerated mass spectrometry protocol described in the standard ASTM D 6866-22.

As used herein, “ethylenically unsaturated compound” refers to a compound comprising a polymerizable ethylenically unsaturated group. By polymerizable ethylenically unsaturated group is meant a carbon-carbon double bond which under influence of an initiator and/or irradiation, eventually in the presence of a photoinitiator, can undergo radical polymerization. The polymerizable ethylenically unsaturated groups are generally from (meth)acrylic groups. In the present invention, the term “(meth)acrylate groups” or “(meth)acryloyl groups” is to be understood as to encompass both acrylate and methacrylate groups present on compounds either separately or as mixtures thereof.

As used herein, “actinic radiation curable composition” refers to a composition that can be polymerized by means of the ethylenically unsaturated groups. Such composition can, at least partially, be cured by electromagnetic radiation such as near infrared, visible light, UV light, or X-rays, in particular UV light, or corpuscular radiation such as an electron beam. With UV light radiation is meant irradiation via a ultraviolet light source including high or low-pressure mercury lamps, cold cathode tubes, xenon lamps, black lights, ultraviolet lasers, and a flash lights, and LED light sources. Typically the wavelength of a UV light source is between 240 and 405 nm. With radiation using LED light sources is meant irradiation via a light-emitting diode source, whereby a semiconductor light source is used. Typically a wavelength of 365, 385, 395 or 405 nm is used. “actinic radiation curable compositions” also includes compositions that are “thermally” curable via polymerization initiated by free-radical generating agents, including peroxide and azo-type initiators. Peroxide initiators include diacylperoxides, hydroperoxides, ketone peroxides, peroxyesters, peroxyketals, dialkyl peroxides, alkyl peresters and percarbonates and the like, used alone or with redox systems. Examples of these peroxides include methyl ethyl ketone peroxide (MEKP), methyl isobutyl ketone peroxide (MIBK), benzoyl peroxide (BPO) and cumene hydroperoxide (CHP). Combinations of two or more peroxides may be used to cure the resin. Azo-type initiators include azobisisobutyronitrile (AIBN) and related compounds.

### Poly(Trimethyleneether)(Meth)Acrylate Compound A

The poly(trimethylene ether) (meth)acrylate compound A having at most two (meth)acrylate groups is obtainable by a condensation reaction of biobased 1,3 poly(trimethylene ether) glycol and a (meth)acrylate compound selected from the group consisting of (meth)acrylic acid, (meth)acryloyl chloride, and/or alkyl esters thereof; wherein the biobased 1,3 poly(trimethylene ether) glycol has a number average molecular weight Mn of from 350 to 600 g/mol, more preferably from 400 to 550 g/mol.

The poly(trimethylene ether) (meth)acrylate compound A is obtainable by a condensation reaction of the biobased 1,3 poly(trimethylene ether) glycol and a (meth)acrylate compound which is selected from the group consisting of (meth)acrylic acid, (meth)acryloyl chloride, and/or alkyl esters thereof. The alkyl ester thereof preferably has a formula of H₂C═C(R)CO₂—R¹—COOH, or H₂C═C(R)CO₂—R¹—Cl, wherein R is H or CH₃, R¹ is a divalent linear alkyl radical having in the range of form 1 to 20, preferably 1 to 5, carbon atoms, a divalent branched alkyl radical having in the range of from 3 to 20 carbon atoms, or a divalent radical having cycloalkyl radical having in the range of from 5 to 10 carbon atoms.

1,3 poly(trimethylene ether) is obtained biochemically from a renewable source. This can be via a fermentation process using a renewable biological source such as e.g. corn feed stock. Examples of commercially available biobased 1,3 poly(trimethylene ether) glycol can be obtained by WeylChem® and are e.g. described in patent application WO 2010 074805.

1,3 poly(trimethylene ether) glycol used for making compound A has a number average molecular weight Mn of from 350 to 600 g/mol, more preferably from 400 to 550 g/mol. 1,3 poly(trimethylene ether) glycol used has a weight average number molecular weight Mw of between 450 and 900 g/mol, preferably from 500 to 650 g/mol. Preferably, the poly(trimethylene ether) glycol has a trimethylene ether repeat unit which is in the range of from 1 to 25, preferably in the range from 1 to 20.

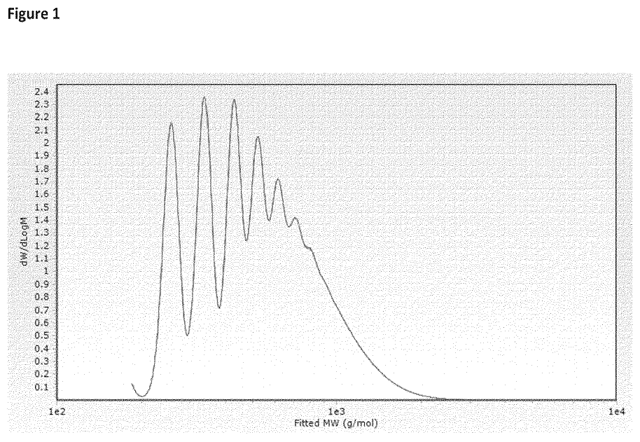

It is surprisingly found that compound A, which has a broad molecular weight distribution, such as e.g. exemplified in FIG. 1, can provide a diluting monomer and has a low viscosity, that even when used in large quantities, can provide coatings with good quality.

The biocarbon content of compound A is preferably at least 50%, more preferably above 60% such as about 66% based on the total carbon content of compound A.

In one embodiment compound A has a viscosity at 25 °C of between 10 and 100 mPas, preferably between 20 and 50 mPas, such as 30 mPas.

The condensation reaction, or esterification, is preferably carried out by reacting 1, 3 poly(trimethylene ether) glycol with a stoichiometric excess of (meth)acrylate groups present on the (meth)acrylate compound selected from the group consisting of (meth)acrylic acid, (meth)acryloyl chloride, and/or alkyl esters thereof. The reactants are generally used in proportions corresponding to an the equivalent ratio of (meth)acrylate groups to alcohol groups of the 1, 3 poly(trimethylene ether) glycol of between 2.0:1.0 and 2.2:1.0.

Preferably the poly(trimethylene ether) (meth)acrylate compound A obtainable by the condensation reaction, comprises at least 90 wt %, more preferably at least 95 wt %, or at least 99 wt % of poly(trimethylene ether) di-(meth)acrylate in view of the total poly(trimethylene ether) (meth)acrylate compound A.

For preparation of the poly(trimethylene ether) (meth)acrylate compound A having at most two (meth)acrylate groups; 1, 3 poly(trimethylene ether) glycol can be contacted, preferably in the presence of a gas, with the (meth)acrylate compound at a temperature from about 25 °C to about 250 °C. The process can be carried out at atmospheric pressure or under vacuum. During reaction, water is formed and can be removed in the inert gas stream or under vacuum to drive the reaction to completion.

To facilitate the reaction of poly(trimethylene ether) glycol with the (meth)acrylate compound, an esterification catalyst is generally used, preferably a mineral acid catalyst. Examples of acid catalysts include but are not restricted to sulfuric acid, aryl or alkyl sulfonic acid, triflic acid, hydriodic acid, and heterogeneous catalysts such as zeolites, heteropolyacid, amberlyst, dialkyl tin dilaurate, titanium alkoxide and ion exchange resin. Preferred esterification acid catalysts are selected from the group consisting of sulfuric acid, p-toluenesulfonic acid, methanesulfonic acid, triflic acid, dialkyl tin dilaurate, titanium alkoxide, and hydroiodic acid. The particularly preferred acid catalyst are sulfuric acid, triflic acid and ion exchange resins. The amount of catalyst used can be from about 0.01 wt % to about 10 wt % of the reaction mixture, preferably from 0.1 wt % to about 5 wt %, and more preferably from about 0.2 wt % to about 2 wt %, of the reaction mixture. To prevent free radical polymerization of (meth)acrylic esters of poly(trimethylene ether) glycol, an inhibitor is used, preferably 4-methoxyphenol. Examples of inhibitors include but are not restricted to alkyl phenols, alkoxyphenol, hydroxybezyl alcohol and hydroquinone. The amount of the inhibitor can be from about 0.001 to 5 wt % of the product. A preferred range is from about 0.01 to 2.0 wt %. The esterification reaction can be conducted in the presence or absence of a solvent. Examples of solvents include but are not restricted to acetonitrile, cyclohexane, hexane, methylcyclohexane, heptane, octane, tetrahydrofuran, toluene and xylene. A preferred solvent is acetonitrile or toluene. The amount of solvent used can be from about 0 wt % to about 100 wt % of the reaction mixture, preferably from 20 wt % to about 100 wt %, and more preferably from about 50 wt % to about 100 wt %, of the reaction mixture.

In one embodiment compound A is added in amount so that the viscosity of the actinic radiation curable composition is between 5 and 50 000 mPas, preferably between 10 and 10000 m Pas, more preferably between 20 and 5000 mPas at application temperature. The application temperature is the temperature the actinic radiation curable coating composition has when the composition is brought in contact with a substrate. In most cases the application temperature (i.e.) is room temperature, but sometimes the actinic radiation curable coating composition is brought in contact with a substrate at a higher temperature.

It is also possible to add besides compound A a low molecular weight ethylenically unsaturated monomer compound C to decrease the viscosity. It is also possible to add in addition to compound A a solvent, e.g. a biobased solvent, to decrease the viscosity. The latter is not preferred. The biobased carbon content will be higher when more of compound A or only compound A is added to the composition.

In yet another embodiment, substantially no further low molecular weight ethylenically unsaturated monomer compound C is added.

In yet another embodiment the poly(trimethylene ether) (meth)acrylate compound A has a number average molecular weight Mn of between 400 and 650 g/mol, more preferably between 450 and 600 g/mol.

In a preferred embodiment the poly(trimethylene ether) (meth)acrylate compound A has a trimethylene ether repeat unit which is in the range of from 1 to 25, more preferably from 1 to 20.

According to another embodiment the poly(trimethylene ether) (meth)acrylate compound A having at most two (meth)acrylate groups, has a weight average molecular weight Mw of between 600 and 850 g/mol.

Compound A is used in an amount from 10 wt % to 90 wt %, preferably from 15 wt % to 70 wt %, and even more preferably from 30 to 50 wt % based on the total weight of the coating composition.

### Ethylenically Unsaturated Oligomer Compound B

The ethylenically unsaturated oligomer compound B is different from compound A, and has a viscosity of more than 5 Pa s, preferably more than 7 Pa s, such as more than 10 Pa s, at 25 °C.

The ethylenically unsaturated oligomer compound B is preferably an oligomer comprising at least one (meth)acrylate group, and include those selected from the group consisting of polyester (meth)acrylates, polyether (meth)acrylates, epoxy (meth)acrylates, amino (meth)acrylates, polycarbonate (meth)acrylates, (poly)urethane (meth)acrylates, (meth)acrylated (meth)acrylics, or mixtures thereof.

Polyester (meth)acrylate oligomers are well known. These (meth)acrylated polyesters can be obtained by reacting a hydroxyl group-containing polyester backbone with (meth)acrylic acid, or by reacting a carboxyl group-containing polyester backbone with a hydroxyalkyl (meth)acrylate such as for example 2-hydroxyethyl acrylate, 2- or 3-hydroxypropyl acrylate, etc. or with glycidyl (meth)acrylate. The polyester backbone can be obtained in a conventional manner by polycondensation of at least one polyhydroxy alcohol, such as ethylene glycol, propylene glycol, butanediol, neopentyl glycol, hexanediol, trimethylolpropane, bisphenol A, or pentaerythritol, etc, and/or the ethoxylates and/or propoxylates thereof, with at least one polycarboxylic acid or anhydride thereof such as adipic acid, phthalic acid, isophthalic acid, terephthalic acid, trimellitic acid, etc. By using unsaturated compounds for the polyester synthesis, such as for example fumaric acid, maleic acid, itaconic acid, etc., polyesters bearing both (meth)acrylic and ethylenic unsaturations in the polymer chain, can be obtained. In addition polylactones and/or polylactides can be used as polyester backbone. For example poly(ε-caprolactone), polylactide and/or poly(lactide, caprolactone) can be obtained by ring-opening polymerization of c-caprolactone and/or lactide optionally in the presence of one or more polyhydroxy alcohols. Examples of suitable polyester (meth)acrylates include EBECRYL® 854, EBECRYL® 5849, EBECRYL® 450, EBECRYL® 452, EBECRYL® 657, EBECRYL® 810, EBECRYL® 852, EBECRYL® 853, EBECRYL® 870, and/or EBECRYL® 892 available from Allnex. Examples of oil-modified polyester (meth)acrylates that may be used are RAYLOK® 1621 and/or RAYLOK® 1622.

Polyether (meth)acrylate oligomers can be prepared by esterification of hydroxyfunctional polyethers with (meth)acrylic acid. Hydroxyfunctional polyethers can be obtained by ring-opening homo- or copolymerization of cyclic ethers such as tetrahydrofuran, ethylene oxide and/or propylene oxide, or can be prepared by reacting polyhydroxy alcohols with ethylene and/or propylene oxide. Other types of polyether acrylate oligomers are e.g. di-pentaerythrytol hexa acrylate (DPHA) and the ethoxylated and/or propoxylated derivatives thereof.

Polycarbonate (meth)acrylate oligomers are also well known. They can be prepared by esterification of hydroxyfunctional polycarbonates with (meth)acrylic acid.

(Poly)urethane (meth)acrylate oligomers can be prepared by reacting a di- and/or polyisocyanate, such as hexamethylene-diisocyanate, isophorone-diisocyanate, toluene-diisocyanate, with hydroxyl functional (meth)acrylate. Use can be made exclusively of hydroxyl functional (meth)acrylates such as those mentioned above, but in order to extend the chain, mono- or polyhydroxy alcohols can also be added, such as those mentioned above for the synthesis of polyesters, polyethers or polycarbonates containing hydroxyl groups.

Examples of suitable urethane (meth)acrylates include EBECRYL® 264, EBECRYL® 265, EBECRYL® 4820 and/or EBECRYL® 4680, all available from Allnex. An example of a suitable aromatic urethane (meth)acrylates: EBECRYL® 210 and/or EBECRYL® 220, all available from Allnex.

By epoxy (meth)acrylate oligomers is meant to designate the (meth)acrylic esters of epoxides, preferably polyepoxides, i.e. compounds comprising at least one, preferably at least two epoxide functions. Epoxy (meth)acrylate oligomers are generally obtained from the esterification reaction of (meth)acrylic acid with epoxides. The epoxides are generally chosen from epoxidized olefins, glycidyl esters of saturated or unsaturated carboxylic acids, glycidyl ethers of aromatic or aliphatic alcohols or polyols and from cycloaliphatic polyepoxides.

Preferred epoxides are diglycidylethers of aromatic and aliphatic diols and cycloaliphatic diepoxides such as diglycidyl ether of bisphenol-A, diglycidyl ether of bisphenol-F, diglycidylether of poly(ethylene oxide-co-propylene oxide), diglycidylether of polypropylene oxide, diglycidylether of hexanediol, diglycidylether of butanediol. Particularly preferred is diglycidyl ether of bisphenol-A. Also epoxidized natural oils or epoxidized phenol-formaldehyde copolymers can be used. Examples of natural oils include soybean oil, linseed oil, perilla oil, fish oil, dehydrated castor oil, tung oil, coconut oil, corn oil, cottonseed oil, olive oil, palm oil, palm kernel oil, peanut oil, sunflower oil, safflower oil, castor oil. Examples of suitable epoxy (meth)acrylates include EBECRYL® 600, EBECRYL® 648, EBECRYL® 645, EBECRYL® 860, EBECRYL® 6040, EBECRYL® 3700 and/or EBECRYL® 3203, all available from Allnex. (Meth)acrylated (meth)acrylic oligomers can be obtained by first preparing a (meth)acrylic copolymer by copolymerization of (meth)acrylate monomers such as butyl acrylate with monomers containing pendant carboxylic acid, anhydride, hydroxy, glycidyl or isocyanate groups and by then reacting this copolymer with a monomer comprising at least one (meth)acrylate functional group and at least one carboxylic acid, anhydride, hydroxyl, glycidyl or isocyanate reactive groups. For example, a glycidyl group-containing copolymer can first be prepared by copolymerizing functionalized monomers such as glycidyl (meth)acrylate with other (meth)acrylate monomers, the said glycidyl group-containing polymer being usually reacted in a second step with (meth)acrylic acid. When the functionalized monomers are (meth)acrylic acid, the carboxyl group-containing polymer is generally reacted in the second step with glycidyl (meth)acrylate. An example of a suitable (meth)acrylated (meth)acrylic is EBECRYL® 1200.

Also amino (meth)acrylates can be added as such to the composition of the invention. Amino(meth)acrylates can be obtained by the addition reaction of a (meth)acrylate and an amine. Examples of suitable amino (meth)acrylates include EBECRYL® 7100, EBECRYL® 80, EBECRYL® 81, EBECRYL® 83, EBECRYL® 85, EBECRYL® 880, EBECRYL® LEO 10551, EBECRYL® LEO 10552 and EBECRYL® LEO 10553, all available from Allnex.

Especially preferred is the ethylenically unsaturated oligomer compound B of which the backbone is derived from biobased compounds, such as fatty acids derived compounds or alcohols that are obtained by further fermentation and/or reacting of plant based material.

The ethylenically unsaturated oligomer compound B is typically a poly(meth)acrylate containing from 2 to 18 (meth)acryloyl groups per molecule. More typically, compound B comprises from 2 to 6 and most typically from 2 to 4 (meth)acryloyl groups. Acryloyl groups are herein preferred.

The ethylenically unsaturated oligomer compound B may be selected in order to enhance the flexibility, strength and/or modulus, among other attributes, of a cured polymer prepared using the polymerizable composition of the present invention.

The ethylenically unsaturated oligomer compound B may have a number average molecular weight equal or more than 500 g/mol, in particular between 800 to 15,000 g/mol, more particularly between 1,000 to 5,000 g/mol.

Compound B is present in an amount from 10 wt % to 89.99 wt %, preferably from 30 wt % to 84.99 wt %, and even more preferably from 50 wt % to 69.99 wt % based on the total weight of the coating composition.

### Low Molecular Weight Ethylenically Unsaturated Monomer Compound C

The low molecular weight ethylenically unsaturated monomers compound C can be any conventional diluting monomers that are actinic radiation curable compound. Typically these compounds have a low viscosity and are added to reduce the viscosity of the curable compositions of the present invention and adjust the flexibility, strength, solubility and/or modulus, among other properties, of finished articles obtained by curing the compositions.

Preferably the viscosity of the low molecular weight ethylenically unsaturated monomers compound C is in the range of from 5 mPa·s to 2 Pa·s at a temperature of 25 °C and most preferably it is <500 mPa·s. Preferably, the low molecular weight ethylenically unsaturated monomers compound C have a number average molecular weight (Mn) in the average range of from 100 to 1000 Daltons, more preferably 200 to 800 Daltons and most preferably 200 to 500 Daltons. Typically the weight average molecular weight (MW) is at most 1000 Daltons.

The low molecular weight ethylenically unsaturated monomers compound C can be monofunctional, i.e. having one ethylenically unsaturated functional group or polyfunctional, i.e. having at least two ethylenically unsaturated functional groups, such as (meth)acrylate functionalized monomers. Ethylenically unsaturated monomer may include, for example, at least one compound selected from the group consisting of cyclic, linear and branched mono-(meth)acrylate-functionalized and mono-(meth)acrylamide-functionalized monomers.

Also vinyl compounds can be used. Suitable vinyl compounds include styrene, [alpha]-methylstyrene, vinyl toluene, bromostyrenes, tert-butylstyrene, N-vinylpyrrolidone, N-vinylcaprolactam, N-vinylformamide, vinyl acetate, vinyl propionate, vinyl pivalate, vinyl stearate, vinyl 2-ethylhexanoate, methyl vinyl ketone, ethyl vinyl ketone, vinyl ethers of C1-C20 alcohols, 2,3-dihydrofuran, vinyl(meth)acrylate, allyl vinyl ether, and divinyl ether of C1-C20 diols, for example.

Suitable (meth)acrylated compounds include butyl(meth)acrylate, methyl(meth)acrylate, isobutyl(meth)acrylate, 2-ethylhexyl(meth)acrylate, cyclohexyl-(meth)acrylate, n-hexyl(meth)acrylate, isobornyl(meth)acrylate, iso-octyl-(meth)acrylate, n-lauryl-(meth)acrylate, octyl/decyl(meth)acrylate, 2-hydroxyethyl(meth)acrylate, phenoxyethyl-(meth)acrylate, nonylphenolethoxylate mono(meth)acrylate, 2-(−2-ethoxyethoxy)-ethyl-(meth)acrylate, 2-butoxyethyl(meth)acrylate, 1,6-hexanediol di(meth)acrylate (HDD(M)A), di or tri propylene glycol di(meth)acrylate (DPGD(M)A, TPGD(M)A), ethoxylated and/or propoxylated neopentylglycol di(meth)acrylate, pentaerythritol tri(meth)acrylate (PETI(M)A) and the ethoxylated and/or propoxylated derivatives thereof, trimethylolpropane tri(meth)acrylate (TMPT(M)A) and the ethoxylated and/or propoxylated derivatives thereof, di-trimethylolpropane tri(meth)acrylate (diTMPT(M)A) glycerol tri(meth)acrylate, dianhydrohexitols di(meth)acrylates (like isosorbide di(meth)acrylate) and the ethoxylated and/or propoxylated derivatives thereof, bisphenol A di(meth)acrylate and the ethoxylated and/or propoxylated derivatives thereof, phenylglycidylether(meth)acrylate and the ethoxylated or/and propoxylated derivatives thereof, the (meth)acrylates obtained from the esterification with (meth)acrylic acid of aliphatic glycidyl ethers, especially those wherein the alkyl chain comprises from 6 to 24 carbon atoms, more preferably from 8 to 18 carbon atoms, and/or of glycidyl esters of saturated and unsaturated carboxylic acids, especially the glycidyl esters of long chain alkyl carboxylic acids wherein the alkyl chain comprises from 6 to 24 carbon atoms, more preferably from 8 to 18 carbon atoms.

Preferred are di and/or tri(meth)acrylated monomers such as 1,6-hexanediol di(meth)acrylate (HDD(M)A), di or tri propylene glycol di(meth)acrylate (DPGD(M)A, TPGD(M)A), trimethylolpropanetri(meth)acrylate (TMPT(M)A) and the ethoxylated and/or propoxylated derivatives thereof, pentaerythritoltri(meth)acrylate (PETI(M)A) and the ethoxylated and/or propoxylated derivatives thereof, glyceroltri(meth)acrylate and the ethoxylated and/or propoxylated derivatives thereof, dianhydrohexitols di(meth)acrylates (like isosorbide di(meth)acrylate) and the ethoxylated and/or propoxylated derivatives thereof, bisphenol A di(meth)acrylate and the ethoxylated and/or propoxylated derivatives thereof. In an embodiment of the invention at least one di and/or tri(meth)acrylated monomer is present in the radiation curable matting composition (II) of the invention. It is preferred to keep the amount of mono-functional (meth)acrylates, in particular of mono-functional alkyl(meth)acrylates, more in particular the amount of C8-C20 mono-functional alkyl(meth)acrylates (like lauryl acrylate) well below the level of 10 wt % (percent by weight), preferably below 8 wt %, more preferably below 5 wt %, relative to the total weight of the matting composition (II) of the invention. In an embodiment of the invention, no mono-functional (meth)acrylates are present at all. In another preferred embodiment of the invention substantially no stenomeric (meth)acrylate monomers are present, in casu added, at all.

An actinic radiation curable coating composition may comprise 35 to 50 wt % by weight of the a low molecular weight ethylenically unsaturated monomer compound C based on the total weight of the radiation curable coating composition.

In one embodiment the actinic radiation curable composition preferably has after curing a Tg (glass transition temperature) of at least 20 °C, more preferably above 25 °C, yet more preferably of at least 30 °C. Typically, the Tg is lower than 160 °C such as lower than 140 °C. Herein the Tg is measured according to standard method ASTM D4065-01 as described below. In another embodiment, the actinic radiation curable composition may have, after curing, a Young's modulus of at least 500 MPa, such as above 700 MPa, or above 1000 MPa.

### Other Components

The actinic radiation curable coating composition of the invention may optionally comprise a polymer compound D having no ethylenically unsaturated groups. Examples of such polymers are saturated polyesters, halogenated or not, hydrocarbons (such as styrene based hydrocarbon resins), styrene allyl alcohols, acrylics (such as acrylic (co)polymers), (poly)urethane resins, polyethylenevinylacetate resins, polyvinylchloride resins, chlorinated polyolefin resins and/or ketone resins. Other types of polymers can be biobased polymers such as polymers and copolymers of lactic acid, cellulose esters (such as cellulose acetate, cellulose propionate, cellulose butyrate and combinations thereof), polyhydroxyalkanoates (e.g. polyhydroxybutyrate and copolymers), lignin derivatives, hemicellulose derivatives, etc.

The actinic radiation curable coating composition of the invention may further comprise between 0.01 and 15 wt %, based on the weight of the composition, of a photoinitiator.

Any photoinitiator or mixtures thereof capable of generating free radicals when exposed to radiation may be used. Preferred photoinitiators include IRGACURE™ 184; acyl phosphine oxides, for example IRGACURE™ 819; benziketals such as IRGACURE™ 651, available from BASF; benzophenones such as ADDITOL® BP available from allnex, IRGACURE™ 1173, and IRGACURE™ BP available from BASF or Speedcure photoiniators from Lambson Ltd.

The curing of the composition can also be performed without the use of photoinitiators.

The composition usually comprises inhibitors. Examples of suitable inhibitors include but are not limited to phenolic inhibitors such as hydroquinone (HQ), methyl hydroquinone (THQ), tert-butyl hydroquinone (TBHQ), parabenzoquinone (BQ), 4-tert butyl catechol, di-tert-butyl hydroquinone (DTBHQ), hydroquinone monomethyl ether (MEHQ), 2,6-di-tert-butyl-4-methylphenol (BHT) and the like. They may also include phosphines, like triphenylphosphine (TPP) and other materials such as tris-nonylphenylphosphite (TNPP), phenothiazine (PTZ), and triphenyl antimony (TPS). When present, inhibitors are preferably present in an amount up to 0.5 wt %, in particular from 0.0001 to 0.2 wt %, and preferably from 0.01 to 0.1 wt % of the composition.

Photostabilizers can be classified as UV absorbers (UVAs), deactivators (quenchers), hydroperoxide decomposers, and radical scavengers known as hindered amine light stabilizers (HALS).

In embodiments, the composition may further comprise a UV absorber and/or a hindered amine light stabilizer. The UVAs protect the polymers by absorbing destructive UV radiation, while the HALS material protects by reacting with the free radicals that occur after a high-energy UV photon breaks a chemical bond in a polymer.

Examples of UVAs are benzotriazoles such as Tinuvin® 328, Tinuvin® 1130, Tinuvin® 900, Tinuvin® 99-2, and Tinuvin® 384-2, triazines such as Tinuvin® 400, Tinuvin® 405, Tinuvin® 460, Tinuvin® 477, and Tinuvin® 479, and benzophenones such as Tinuvin® 531.

Examples of HALS are Tinuvin® 123, Tinuvin® 144, and Tinuvin® 292, 2,2,6,6-tetramethylpiperidine and 2,6-di-tert-butylpiperidine.

Photostabilizers, when present, may be used in an amount of from 0.1 to 5.0, preferably from 0.5 to 2.5 wt % of the composition.

The composition may comprise further additives such as fiber wetting agents e.g. functionalized silanes; and (acidic) adhesion promotors.

The actinic radiation curable coating composition of the invention may contain other conventional ingredients including coalescing organic solvents, pigments, dyes, heat stabilizers, defoamers, leveling agents, anti-agents, fillers, sedimentation inhibitors, UV absorbers, antioxidants and the like introduced at any stage of the preparation process or subsequently.

In another aspect, the invention is related to the use of the poly(trimethylene ether) (meth)acrylate compound A having at most two (meth)acrylate groups as described above as a diluting monomer in an actinic radiation curable coating composition.

In one embodiment of this aspect, the poly(trimethylene ether) (meth)acrylate compound A having at most two (meth)acrylate groups, is added in the actinic radiation curable coating composition in an amount of from 10 to 90 wt %, preferably from 15 wt % to 70 wt %, and even more preferably from 30 to 50 wt % based on the total weight of the coating composition.

In another embodiment of this aspect is the poly(trimethylene ether) (meth)acrylate compound A having at most two (meth)acrylate groups, is added in amount so that the viscosity of the actinic radiation curable composition is between 5 and 50 000 mPa s, preferably between 10 and 10 000 mPa s, more preferably between 20 and 5000 mPa s at application temperature.

In a third aspect, the invention is related to a method of forming a coating comprising applying a layer of the actinic radiation curable coating composition as described above to at least a portion of a substrate and submitting the coated substrate to curing conditions.

The way of applying the layer of the actinic radiation curable coating composition can e.g. occur via spraying of e.g. wood and plastic substrates.

In one embodiment according to this aspect are the curing conditions selected from peroxide curing, LED curing, UV curing and/or electron beam curing.

In another embodiment, the substrate is selected from the group consisting of wood, plastic, leather, metal, composite, ceramic, paper and mineral substrates like glass.

In a fourth aspect, the invention is related to the use of the actinic radiation curable composition in additive manufacturing, laminating adhesives, water proofing membranes or inks, such as flexographic inks.

In yet another aspect, the invention is related to a substrate that is in contact with a coating composition as described above.

### Material:

Velvetol® H250: Polypropanediol with an average number molecular weight Mn of between 200 and 300 and a Hydroxyl no. of between 370 and 550 mg KOH/g (Weylchem®)
Ebecryl® 6000: diacrylate ester of bisphenol A epoxy resin with a viscosity at 25 °C of >10000 mPa s—available from Allnex®
Ebecryl®5849: EBECRYL® 5849 is a high performing medium viscosity biobased aliphatic diacrylate. Viscosity at 25 °C: 7000-12000 mPa s
TPGDA: Tripropylene glycol diacrylate—available from Allnex®
DPGDA: Dipropylene Glycol Diacrylate—available from Allnex®
OTA 480: OTA-480 is a triacrylated reactive diluent based on a glycerol derivative—available from Allnex®
Additol® MBF: Methyl benzoyl formate—available from Allnex®
Ebecryl® 7100: an acrylate functional oligomeric amine resin available from Allnex®
Ebecryl® 8811 is difunctional aliphatic urethane acrylate available from Allnex®
BHT: Butylated hydroxy toluene
pBTC: para-butyl catechol
Ebecryl® LED 03: a low viscosity amine modified polyether acrylate oligomer—available from Allnex®
ADDITOL® TPO (TPO-L) is a radical photoinitiator—available from Allnex®

### Methods

The number average molecular weight Mn and the weight average molecular weight Mw are determined by conventional gel permeation chromatography (GPC) with Polystyrene standards. The polystyrene standards used are EasyCal from Polymer Laboratories (Molecular Weight range: 200-400.000 g/mol). The sample was dissolved (1.0 wt %) in tetrahydrofuran (THF) containing 0.5% toluene as Flow rate marker. Analysis are performed by liquid chromatography (Agilent 1260) equipped with 3 PLGel Mixed-D LS polystyrene-divinylbenzene GPC columns (300×7.5 mm×5 μm). The components of the sample were separated by the GPC columns based on their molecular size in solution and detected by a Refractive Index detector. Data were gathered and processed by Agilent GPC/SEC software. It is important to note that the sample was filtrated over 0.45 μm regenerated cellulose Whatman filter (Spartan™ 30/0.45 RC) prior to injection into the GPC system.

Viscosity is measured according to DIN EN ISO 3219 using a rotational rheometer in cone and plate configuration at a shear rate of 20 s⁻¹.

### Coating Preparation

In order to determine the glass transition and tensile properties, the liquid UV-curable compositions were applied using a bar coater on a glass substrate cleaned beforehand with acetone and isopropanol. The coating layers were cured using a belt conveyor running at a speed of 5 m min⁻¹ and equipped with two UV lamps in series, respectively a 80 W cm⁻¹ Ga-doped medium-pressure mercury vapor (Hg) lamp followed by a 80 W cm⁻¹ medium pressure Hg lamp. After curing, the coatings were recovered from the glass substrate as a free-standing film.

### Glass Transition Properties

The glass transition temperature (Tg) marks the boundary between the glassy, rigid state and the softer relaxed state of a polymer or polymer network which can be rubbery or even fluid.

A suitable method for the determination of the glass transition temperature of solid polymers or cured polymer networks is dynamical mechanical thermal analysis (DMTA) as for instance described by the standard method ASTM D4065-01 (Standard test method for the assignment of the glass transition temperature by Dynamic Mechanical Analysis).

DMTA measurements were conducted using a DMA Q800 (TA Instruments) instrument in tensile mode. The dimensions of the samples between the clamps are typically 11 mm×8.0 mm×0.04 mm. A periodic strain deformation is applied with an amplitude of 30 μm at a frequency of 1 Hz. The viscoelastic properties are measured following a temperature profile increasing from −50 to 200 °C at a heating rate of 3 °C per minute. The Tg is determined as the temperature at the maximum of the loss factor curve (i.e. T(tan δₘₐₓ)).

### Tensile Properties

Young's modulus or tensile modulus of elasticity are mechanical properties that provide an index for the degree of stiffness of a solid material. It defines the relationship between tensile stress (force per unit area) and tensile strain (relative deformation) of a material for small uniaxial deformation. Young's modulus (Ey) is the ratio of the tensile stress to the tensile strain, and is reported in pressure units. The ultimate tensile elongation (UTE) or elongation at break (in %) describes the resistance of the material against failure. Tensile properties are reported at a temperature of 23 °C according to one of the following standard methods for the determination of tensile properties, ASTM D638 (Standard Test Method for Tensile Properties of Plastics), ASTM D882 (Standard Test Method for Tensile Properties of Thin Plastic Sheeting) or IS0527-1 (Plastics—Determination of tensile properties).

### Reactivity

For successful application, the UV-curable composition should demonstrate a high reactivity upon exposure to UV-light. In order to assess the reactivity properties, the liquid UV-curable compositions were applied with a thickness of 20-25 μm onto white non absorbing paper. UV-curing was conducted in a similar way as described earlier for the glass substrate. The conveyer speed is varied in order to determine the maximum conveyer speed to be used to obtain a thoroughly cured film. The level of curing is assessed by applying some fine graphite powder on the coating surface, rubbing with a finger and then with a cotton. As long as a dark mark persist after removing the excess graphite powder, the film is not well cured and the conveyer speed must be reduced to increase UV exposure. The coating is also submitted to 100 double rubs using a cotton soaked in acetone. A well cured film is not visually affected after this test. The UV-dose (expressed as the conveyer speed (m min⁻¹) at a fixed power of the UV lamp (W cm⁻¹) required to pass the two tests is referred to as the reactivity of the coating.

### Adhesion

A film of 20-22 μm is applied on the primer and fully cured as described in the reactivity method. A square pattern is engraved in the coating with a cutter. A string of adhesive tape (Tesa 4104) is pressed on the surface and the interlayer is degassed. The tape is then snatched off. Based on the number of squares removed by the tape, a value of adhesion is given: 0B (100% of the squares removed), 1B (65-35% of the squares removed), 2B (35-15% of the squares removed), 3B (15-5% of the square removed), 4B (less than 5% of the squares removed, 5B (0%).

### Scratch Resistance

Hamberger-Höbel (coin test): a full coating system is applied on sanded beech, cured and placed on the Hamberger Höbel tester. The apparatus is equipped with a screw that can be turned in such a way that the pressure of a coin on the coating can be varied. The load is increased stepwise until a scratch of a few centimeters is made on the coated surface. The higher the load value, the better the scratch resistance. The scratch resistance is expressed in Newton.

### Abrasion Test

Grit feeder: This method is based on the standard test method ASTM F510-93 and uses a Taber abrader 5150 with leather-covered wheels (S-39); sand used in the test is of the type Alodur ESK 240 EN 14354 from Treibacher. A full coating system is applied on sanded beech and cured. All equipment and substrates are conditioned at least 24 hours in the conditioned room (21±1 °C, 50±5% relative humidity) before testing. The coated substrates are abraded in steps of 500 cycles until spots appear where the coating is completely removed (initial point). The initial point is reached when blues spots are formed on the test specimen after application of a methylene blue solution. After determination of the initial point, abrasion is carried out for another 500 cycles. Again, a methyleneblue solution is applied for visual comparison. Abrasion is measured by weight loss (in mg, accuracy of ±0.1 mg) after each 500 cycles step.

### Persoz Pendulum Hardness (ASTM D4366)

The Persoz Pendulum Hardness Test measures the time for the amplitude of the Persoz pendulum to decrease from 120 to 4°. A 60 micron thick film is applied on a glass plate and cured with Electron beam at 250 kVolt-3 kGy.

Yellowing after Cure

UV curing coatings tends to occur yellowing after curing, especially on white or light-colored substrates. Concerning the yellowing issue, the Δb value is taken as yellowing index and is investigated at reactivity cure speed, after 2 hrs and 2 days.

### Pigment Wetting

Pigment wetting is the first step of dispersing a pigment in formulation. Sufficient wetting is crucial; this involves surrounding the pigment particles in liquid instead of air to reduce surface tension, before proceeding with steps such as milling. The wetting performance is measured via the viscoelastic property of the pigment-resin mixture.

### Stain Resistance

Stain resistance is defined as the ability to resist to several common stains, and it is an important performance of interior and exterior coatings. It is measure by exposing the coating to a droplet of the stain during a definite number of hrs and temperature. The integrity of the coatings is assessed after the exposure (rating: 5 No visual stain//4: Very light stain//3: Moderate stain//2: Strong stain//1: Very strong stain//0 coating damaged). The curing is done under the optimal performance conditions of the coating: thickness: 20 μm, curing: EB cure at 250 kV-30 kGy. Usually, a white leneta paper substrate is used.

### Coating on Wood

Wood coatings typically consist of different layers, each with special characteristics. A typical system comprises a primer, a sealer and is finished with a top coat. For an optimum performance of the total coating systems, an excellent intercoat adhesion is highly desirable.

### Base Coat

A basecoat is typically the first layer of paint or other coating material that serves as the base on which the top or finishing coat is applied. If a primer coat is required, the basecoat is applied over it. The basecoat is usually formulated with pigments, fillers and plasticizers to cover minor surface imperfections and enhance the color and overall visual appearance of the top coating. A 20 micron coating is applied on leneta paper and cured under EB 250 kV-30 kGy. The base coat performance is measured by Persoz hardness and stain resistance.

### Clear Coat

A clear coat (often referred to as a finish or topcoat) is basically a clear protective layer that is applied on top of the cured base coat. This layer gives the substrate the final protection against scratches, solvents and stains. A 20 micron coating is applied on top of the base coat and cured with 4 wt % photo-initiator MBF with a combination of Ga+Hg lamps. The Clear coat performance is measured by adhesion on the base coat and stain resistance.

### Sealer

A sealer coating can be pigmented and provides a layer of protection to the wood and prevents the grain from rising. It is a common practice to apply a sealer to prevent bleeding of the wood. A sealer coating can be applied several times after sanding to obtain a smooth surface. The sealer coating is cured with 4 wt % TPO-L photo-initiator and a Ga lamp, sometimes in combination with LED.

### Synthesis of poly(trimethylene ether) di-(meth)acrylate (PPDODA) (Compound A)

1 mol equivalent Velvetol® H250, 150 g toluene, 0.3 g methoxyphenol and 2 mol equivalent acrylic acid is taken in a 250 ml three neck round-bottom flask and this mixture is refluxed for 3 hours. After three hours, a distillation head was attached to the flask and the solvent was distilled out from the reaction mixture at 85 °C. The temperature was slowly raised to 115 °C and the reaction was allowed to continue for 90 minutes at 115 °C. The reaction mixture was allowed to cool to room temperature and then diluted with 100 ml of deionized (DI) water. To purify the aqueous mixture, it was mixed thoroughly and transferred to separating funnel. The organic product was collected and dried using rotary evaporator at 35 °C. The acrylic ester product, was stabilized by 200 ppm of 2,6-bis(1, 1-dimethylethyl)-4-methylphenol (BHT) and the product was analyzed using proton NMR.

The obtained product has the following properties
Viscosity (Cone and plate, 25 °C, 20 s⁻¹): 30 mPa s
Mn: 500 g/mol
Mw: 810 g/mol

### Example 1. Diluting Power of PPDODA in Ebecryl 6000 in Comparison to Conventional Di-Acrylate Monomers

The viscosity at 25 °C of different ratios of PPDODA with Ebecryl 6000 (EB 6000) were made and compared with standard monomers (Table 1).

Table 1. Viscosity of EB 6000 Diluted with PDDODA in Comparison to Conventional Monomers.

| | | Viscosity, mPa s | | | |
|---|---|---|---|---|---|
| EB 6000 | Monomer | Cone and plate, 25 °C, 20 s⁻¹ | | | |
| wt % | wt % | PDDODA | TPGDA | DPGDA | OTA 480 |
| 75 | 25 | 8900 | 13200 | 9820 | 39000 |
| 65 | 35 | 2800 | 3760 | 2650 | 13750 |
| 55 | 45 | 1000 | 1150 | 830 | 5100 |

Using EB6000 in this example, it can be concluded that PDDODA has a strong dilution power, similar to DPGDA.

### Example 2. Tensile Properties of UV-Cured Films Based on EB 6000/PPDODA in Comparison to Conventional Di-Acrylate Monomers

Free films of 120 μm were prepared of mixtures Eb 6000 with PPDODA and compared with standard monomers. The mixtures contained 5 wt % of a photo-initiator (Additol CPK from allnex). Curing was done using a belt conveyor running at a speed of 5 m/min and equipped with two UV lamps in series, respectively a 80 W cm⁻¹ Ga-doped medium-pressure mercury vapor (Hg) lamp followed by a 80 W cm⁻¹ medium pressure Hg lamp.

Table 2. Tensile Properties of Cured Films Based on PPDODA/EB 6000 (35/65) in Comparison with Conventional Monomers

| | EB 6000 | | | |
|---|---|---|---|---|
| | 65 wt % | | | |
| 35 wt % dilution | PDDOA | TPGDA | DPGDA | OTA 480 |
| Ultimate tensile elongation (%) | 3.3 ± 1.3 | 1.1 ± 0.3 | 1.0 ± 0.2 | 1.3 ± 0.2 |
| Tensile strength at break (MPa) | 36 ± 10 | 17 ± 5 | 16 ± 4 | 19 ± 2 |
| Young modulus (MPa) | 1460 ± 103 | 1630 ± 130 | 1720 ± 78 | 1620 ± 84 |
| Tg (°C) | 84 | 88 | 96 | 92 |

With similar Young's modulus, PPDODA provides a coating with a higher ultimate tensile elongation and tensile strength when compared to a composition diluted with conventional monomers.

### Example 3. Tensile Properties of UV-Cured Films Based on EB 5849/PPDODA in Comparison to Conventional Di-Acrylate Monomers

Free films of 120 μm were prepared of mixtures Eb 5849 with PPDODA and compared with standard monomers. The mixtures contained 5 wt % of a photo-initiator (Additol CPK). Curing was done using a belt conveyor running at a speed of 5 m/min and equipped with two UV lamps in series, respectively a 80 W cm⁻¹ Ga-doped medium-pressure mercury vapor (Hg) lamp followed by a 80 W cm⁻¹ medium pressure Hg lamp.

Table 3. Tensile Properties of Cured Films Based on PPDODA/EB 5849 (40/60) in Comparison with Conventional Monomers

| | EB 5849 | | | |
|---|---|---|---|---|
| | 60 wt % | | | |
| 40 wt % dilution | PDDODA | TPGDA | DPGDA | OTA 480 |
| Ultimate tensile elongation (%) | 1.4 ± 0.8 | 0.7 ± 0.2 | 0.6 ± 0.1 | 0.2 ± 0.1 |
| Tensile strength at break (MPa) | 17.0 ± 11.6 | 12.2 ± 3.3 | 9.6 ± 2.1 | 3.5 ± 1.3 |
| Young modulus (MPa) | 1250 ± 255 | 1690 ± 80 | 1770 ± 89 | 1620 ± 31 |
| Tg (°C) | 83 | 108 | 120 | 99 |

It is shown that compared to classical monomers, PDDODA gives a higher elongation and toughness (strength at break) and a comparable Young modulus.

### Example 4. Use of PPDODA as Diluent in Coating Formulation for Wood Coating

### Base Coat

The base coats were prepared using EB 5849 with a diluent and applied as described above.

Table 4. Base Coat Performance of PPDODA/EB 5849 (60/40) in Comparison with Conventional Monomers

| | | | | |
|---|---|---|---|---|
| Monomer | PPDODA | OTA 480 | DPGDA | TPGDA |

24 h stain test: 20 μm wet coat, EB cure: 250 kVolt-30 kGy.

| | | | | |
|---|---|---|---|---|
| Coffee | 4 | 5 | 5 | 5 |
| Mustard | 5 | 5 | 5 | 5 |
| 2% Eosine/water | 5 | 5 | 5 | 5 |
| M-blue | 2 | 2+ | 2+ | 3 |
| Black marker | 5 | 5 | 5 | 5 |
| IPA clean | | | | |

5 No visual stain // 4: Very light stain // 3: Moderate stain //
2: Strong stain // 1: Very strong stain// 0 coating damaged:
Viscosity at 25 °C

| | | | | |
|---|---|---|---|---|
| mPa s | 235 | 450 | 298 | 380 |

Persoz hardness (60 μm EB cure coat on glass)

| | | | | |
|---|---|---|---|---|
| seconds | 277 | 317 | 327 | 326 |

Table 4 shows that the diluent monomer PPDODA provides a high stain resistance and a very good Persoz hardness

### Clear Topcoat

The clear coats were prepared using Eb 6000 or Eb 5849 with a diluent and applied as described above.

TABLE 5
Clear coat performance of PPDODA with EB 6000 or EB
5849 (40/60) in comparison with conventional monomers

| | | Clear coat oligomer | | | | | | | |
|---|---|---|---|---|---|---|---|---|---|
| | | EB 6000 | | EB 5849 | | EB 6000 | | EB 5849 | |
| | | Adhesion: 0 = excellent | | | | | | | |
| | | 0 | | 0 | | 0 | | 0 | |
| | | Monomer | | | | | | | |
| | | OTA | PPDODA | OTA | PPDODA | OTA | PPDODA | OTA | PPDODA |
| 24 hours | Coffee | 5 | 5 | 4 | 4 | 5 | 5 | 5 | 4 |
| stain | Mustard | 5 | 5 | 3 | 3 | 5 | 5 | 5 | 4 |
| | Eosine | 5 | 5 | 3 | 3 | 5 | 5 | 4 | 3 |
| | M-bleu | 2 | 2 | 2 | 2 | 3 | 3⁻ | 2 | 2 |
| | Black marker | 5 | 5 | 3 | 5 | 5 | 5 | 2 | 4 |

5 No visual stain//4: Very light stain//3: Moderate stain 12: Strong stain//1: Very strong stain//0 coating damaged:
Adhesion 0/5: 0=excellent, 5=full delaminated.

Table 5 shows that coatings diluted with PPDODA have a very high adhesion and very good stain resistance

### Pigmented Top Coat

The pigmented sealer based on PPDODA, in comparison with OTA480, were prepared and applied as described above.

Table 6. Performance of PPDODA/EB6000 (40/60) in White Pigmented Sealer with Clear Coat (as Above) on Wood

| White sealer | Eb 6000/OTA480 | Eb 6000/PPDODA |
|---|---|---|
| UV cure | GA | GA |
| Clear Top coat | EB 5849/OTA | EB 5849/PPDODA |
| UV cure Top | | |
| Adhesion | 5 | 1 |
| Erickens scratch N | 6 | 12 |
| Hamberger scratch | ≤5 | 10 |
| N | | |
| 24 hours stain test | | |
| Coffee | 4 | 3 |
| Mustard | 3 | 3 |
| 2% Eosine | 3 | 3 |
| M-blue | 2 | 2 |
| Black marker | 3 | 3 |

5: No visual stain//4: Very light stain//3: Moderate stain//2: Strong stain//1: Very strong stain//0 coating damaged. Adhesion 0/5: 0 perfect, 5 full delaminated.

Table 6 shows that PPDODA, as compared to OTA480, provides an equal dilution power, better adhesion (due to softened coating) and flexibility (mechanical properties). Stain resistance and pigment wetting remains equal to the OTA based top coat formulation.

### Example 5. The PPDODA can Also be Used as Diluent Monomer for LED Curing

A typical formulation for LED cure was used to compare PPDODA with TPGDA. In LED radical inhibitors and special additives (e.g. LED 03) play an important role to obtain sufficient surface cure. Therefore, an alignment on inhibitor content is needed.

The reactivity is assessed by the “thumb twist” method, which gives an indication of the surface cure. The lower the number of passes at 5 m/min under the lamp to obtain a good thumb twist result the better is the reactivity.

TABLE 7

| | | | | |
|---|---|---|---|---|
| Eb8811 | 50 | 50 | 45 | 45 |
| TPGDA* blend + 850 ppm BHT + | | 50 | | 45 |
| 1900 ppm pBTC | | | | |
| PPDODA | 50 | | 45 | |
| LED 03 | | | 10 | 10 |
| TPO-L | 5 | 5 | 5 | 5 |
| White leneta 20 μm barcoater | | | | |
| Viscosity (mPa s) | 1632 | 1338 | 1691 | 1237 |
| Reactivity 395 nm (# passes at 5 m/min) | 8 | >15 | 3 | 4 |
| Evaluated using “thumb twist” | | | | |

*stabilizer content is adjusted to the level of PPDODA

Table 7 shows that the coating formulation diluted with PPDODA has a much higher reactivity, even when cured with LED, compared to a coating formulation diluted with TPGDA.

1. An actinic radiation curable coating composition comprising the following compounds:
from 10 wt % to 90 wt %, based on the total weight of the coating composition, of a poly(trimethylene ether) (meth)acrylate compound A having at most two (meth)acrylate groups obtainable by a condensation reaction of biobased 1,3 poly(trimethylene ether) glycol and an (meth)acrylate compound selected from the group consisting of (meth)acrylic acid, (meth)acryloyl chloride, and/or alkylesters thereof, wherein the biobased 1,3 poly(trimethylene ether) glycol has a number average molecular weight Mn of from 350 to 600 g/mol, more preferably from 400 to 550 g/mol;
from 10 wt % and 89.99 wt %, based on the total weight of the coating composition, of an ethylenically unsaturated oligomer compound B different from compound A, wherein compound B has a viscosity at 25 °C of more than 5 Pa s;
optionally, a low molecular weight ethylenically unsaturated monomer compound C;
optionally, a further compound D which is a polymer without a reactive ethylenically unsaturated group.

2. The actinic radiation curable composition according to claim 1, wherein the poly(trimethylene ether) (meth)acrylate compound A is added in amount so that the viscosity of the actinic radiation curable composition is between 5 and 50 000 mPa s at application temperature.

3. The actinic radiation curable composition according to claim 1, wherein substantially no further low molecular weight ethylenically unsaturated monomer compound C is added.

4. The actinic radiation curable composition according to claim 1, wherein the poly(trimethylene ether) (meth)acrylate compound A has a number average molecular weight Mn of between 400 and 650 g/mol, more preferably between 450 and 600 g/mol.

5. The actinic radiation curable composition according to claim 1, wherein the poly(trimethylene ether) (meth)acrylate compound A has a weight average molecular weight Mw of between 600 and 850 g/mol.

6. The actinic radiation curable composition according to claim 1, wherein the poly(trimethylene ether) (meth)acrylate compound A has a trimethylene ether repeat unit which is in the range of from 1 to 25.

7. The actinic radiation curable composition according to claim 1, wherein the ethylenically unsaturated oligomer compound B is at least one (meth)acrylate-functionalized oligomer selected from the group consisting of (meth)acrylate esters of aliphatic mono-alcohols, (meth)acrylate esters of alkoxylated aliphatic mono-alcohols, (meth)acrylate esters of aliphatic polyols, (meth)acrylate esters of alkoxylated aliphatic polyols, (meth)acrylate esters of aromatic alcohols, (meth)acrylate esters of alkoxylated aromatic alcohols, epoxy (meth)acrylates, polyether (meth)acrylates, urethane (meth)acrylates, polyester (meth)acrylates and amine- and sulfide-modified derivatives thereof and combinations thereof.

8. The actinic radiation curable composition according to claim 1, wherein biocarbon content of compound A, oligomer compound B and compound C and/or compound D, if present, is more than 5%, preferably above 30%, more preferably above 50%, even more preferably above 60%, by weight of the total carbon content, wherein the biocarbon content is measured using the accelerated mass spectrometry protocol described in the standard ASTM D 6866-22.

9. The actinic radiation curable composition according to claim 1, wherein the radiation curable composition further comprises between 0.01 and 15 wt %, based on the weight of the composition, of a photoinitiator.

10. The actinic radiation curable composition according to claim 1, wherein the radiation curable composition after curing has a Tg of at least 20 °C, wherein the Tg is measured according to standard method ASTM D4065-01.

11. Use of the poly(trimethylene ether) (meth)acrylate compound A having at most two (meth)acrylate groups, according to claim 1, as a diluting monomer in an actinic radiation curable coating composition.

12. Use according to claim 11, wherein the poly(trimethylene ether) (meth)acrylate compound A is added in the actinic radiation curable coating composition in an amount of from 10 to 90 wt % based on the total weight of the coating composition.

13. Use according to claim 11, wherein the poly(trimethylene ether) (meth)acrylate compound A is added in amount so that the viscosity of the actinic radiation curable composition is between 5 and 50 000 mPas at application temperature.

14. Method of forming a coating comprising applying a layer of the actinic radiation curable coating composition according to claim 1, to at least a portion of a substrate and submitting the coated substrate to curing conditions.

15. Method according to claim 13, wherein the curing conditions are selected from peroxide curing, LED curing, UV curing and/or electron beam curing.

16. The method according to claim 13, wherein the substrate is selected from the group consisting of wood, plastic, leather, metal, ceramic, paper and mineral substrates like glass.

17. Use of the actinic radiation curable composition according to claim 1 in additive manufacturing, laminating adhesives, water proofing membranes, composite material or inks.

18. A substrate that is in contact with a coating composition according to claim 1.
